(19) United States
(12) Patent Application Publication
(10) Pub. No.: US 2025/0047034 A1
(43) Pub. Date: Feb. 6, 2025

(54) PLUG CONNECTOR BUCKLE PRESS RELEASE MECHANISM AND THE MATCHING SOCKET CONNECTOR

(71) Applicant: ACES ELECTRONICS CO., LTD., Taoyuan City (TW)

(72) Inventor: Kuo-Hua HUANG, Taoyuan City (TW)

(21) Appl. No.: 18/676,941

(22) Filed: May 29, 2024

(30) Foreign Application Priority Data
Aug. 2, 2023 (TW) 112208180

(51) Int. Cl. H01R 13/629; H01R 13/627

(52) U.S. Cl. CPC H01R 13/629; H01R 13/6273

(57) ABSTRACT

A plug connector buckle press release mechanism includes connector including a base block assembled with a cover shell and provided with a docking portion at the front, two positioning portions at two opposite sides and a limiting space in each positioning portion and a mating terminal set mounted in the base block, and buckle assembly includes a connecting portion positioned on base block and two elastic arms respectively located in the limiting spaces of the positioning portions, each elastic arm having a pressing portion exposed to the cover shell and a buckle portion exposed to said cover shell. When the pressing portions are pressed, the elastic arms will elastically deflect inward by a distance with the pressing portions as the axis, thereby forming a locked or unlocked state. A socket connector matching up with the plug connector buckle press release mechanism is also provided.

This application claims the priority benefit of Taiwan patent application number 112208180, filed on Aug. 2, 2023.

### BACKGROUND OF THE INVENTION

### 1. Field of the Invention

The invention relates to a plug connector buckle press release mechanism, and in particular to a plug connector buckle press release mechanism in which a buckle assembly and a cover shell are provided on the base block of a plug connector so that when press the pressing portions on both sides of the base block at the same time, the arm bodies on both sides of the buckle assembly are elastically deflected by a distance, so as to form a stable docking or separation effect in the corresponding socket connector.

### 2. Description of the Related Art

Nowadays, computer technology is developing at a rapid pace, and the development trend of computers is also moving towards strong computing power, fast speed and small size, and the number of computer communication ports is also reduced. This kind of communication ports can also be used with other devices with the same specifications, such as car audio, car computers, charging devices, satellite navigation, communication devices, etc. However, these devices contain communication port plugs, so the future development of such plugs with communication ports is also on the rise. However, with the improvement of technology in recent years, the size of plugs has become smaller and smaller. In terms of overall structural configuration, how to use good structural design to prevent the plug from directly pulling on the internal cable when plugging and unplugging, and to avoid the plug and socket connector from being too small and easily damaged. In addition, without any support or fixed structure for the plug, it is easy for the plug to be pulled and fall off after being inserted into the socket, thus affecting the signal transmission. Therefore, from the above detailed description, it can be found that when designing the plug, the main consideration can be to ensure the stability of the plug when docking with the socket connector. During use, it should be avoided to pull on the wire to cause the plug to detach. Therefore, in view of the shortcomings of the above-mentioned conventional designs, it is necessary for relevant industries to conduct additional research and development to improve the shortcomings of the conventional designs.

Therefore, in view of the above-mentioned problems and deficiencies, the inventor collected relevant information, evaluated and considered many aspects, and used his many years of experience in this industry to design this kind of plug connector buckle press release mechanism and the plug and socket connector set using the plug connector buckle press release mechanism.

### SUMMARY OF THE INVENTION

It is therefore the main object of the present invention to provide a plug connector buckle press release mechanism, comprising a connector, a buckle assembly and a cover shell, wherein the connector comprises a base block externally assembled with the cover shell, a mating terminal set mounted in the base block, a docking portion formed on the front side of the base block, and two positioning portions respectively formed on two opposite lateral sides of the base block and respectively provided with a limiting space; the buckle assembly comprises a connecting portion positioned at the rear side of the top surface of the base block and two elastic arms respectively extended in the same direction on two opposite sides and respectively located in the limiting spaces of the positioning portions. Each elastic arm comprises an arm body extended perpendicular to the connecting portion, a pressing portion formed of a part of the respective arm body and exposed to the cover shell, and a buckle portion provided on the respective arm body near the distal end of the respective arm body and exposed to the cover shell. When the pressing portions of the two elastic arms are pressed, the pressing portions of the two elastic arms will elastically deflect the two arm bodies inward by a distance with the pressing portions as the axis, thereby forming a locked or unlocked state.

It is another object of the present invention to provide a plug connector buckle press release mechanism, comprising a connector, a buckle assembly and a cover shell, wherein the connector comprises a base block externally assembled with the cover shell, a mating terminal set mounted in the base block, a docking portion formed on the front side of the base block, and two positioning portions respectively formed on two opposite lateral sides of the base block and respectively provided with a limiting space; the buckle assembly comprises a connecting portion positioned at the rear side of the top surface of the base block and two elastic arms respectively extended in the same direction on two opposite sides and respectively located in the limiting spaces of the positioning portions. Each elastic arm comprises an arm body extended perpendicular to the connecting portion, a pressing portion formed of a part of the respective arm body and exposed to the cover shell, and a buckle portion provided on the respective arm body near the distal end of the respective arm body and exposed to the cover shell. When the docking portion of the plug connector of the present invention is inserted into the socket portion of the socket connector to form an electrical connection, the arm bodies of the two elastic arms are extruded by the side wall panels on both sides of the socket connector and are elastically deflected inward by a distance, and after the buckle portions of the arm bodies move to the buckle holes, the buckle portions are elastically reset and fastened to the buckle holes to form positioning. When the pressing portions exposed on both sides of the cover shell are pressed to unlock, the arm bodies are elastically deflected inward by a distance with the pressing portions as the axis, so that the buckle portions are separated from the buckle holes, and the plug connector can then be easily disconnected from the electrical connection of the socket connector, achieving the effect of stable docking and separation through the elastic deflection of the arm bodies of the two elastic arms.

It is another object of the present invention to provide a plug connector buckle press release mechanism, comprising a connector, a buckle assembly and a cover shell, wherein the connecting portion of the buckle assembly and the two elastic arms are connected with two buffer portions that are turned downward, so that when the pressing portions of the two elastic arms are pressed and elastically deflected, the stress can be released, thereby preventing the elastic arms from breaking.

### BRIEF DESCRIPTION OF THE DRAWINGS

FIG. 1 is a three-dimensional appearance view of the present invention.

FIG. 2 is an exploded view of the plug and socket connector set of the present invention.

FIG. 3 is an exploded view of the plug connector of the present invention.

FIG. 4 is another perspective exploded view of the plug connector of the present invention.

FIG. 5 is a three-dimensional appearance view of the connector combined with the buckle assembly of the present invention.

### DETAILED DESCRIPTION OF THE PREFERRED EMBODIMENT

In order to achieve the above objects and effects, the technical means and structures adopted by the present invention are described in detail below with respect to the preferred embodiment of the present invention in companying with the drawings, so as to facilitate a complete understanding.

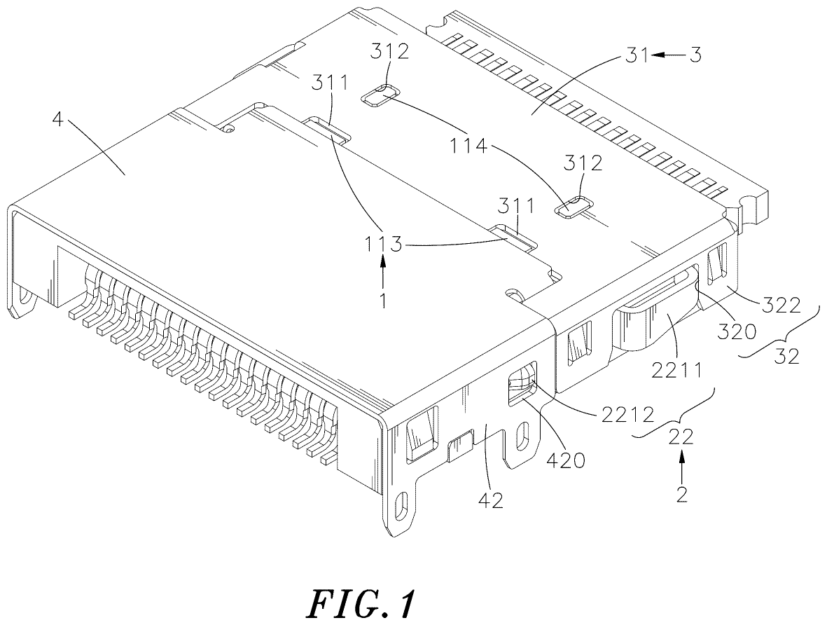

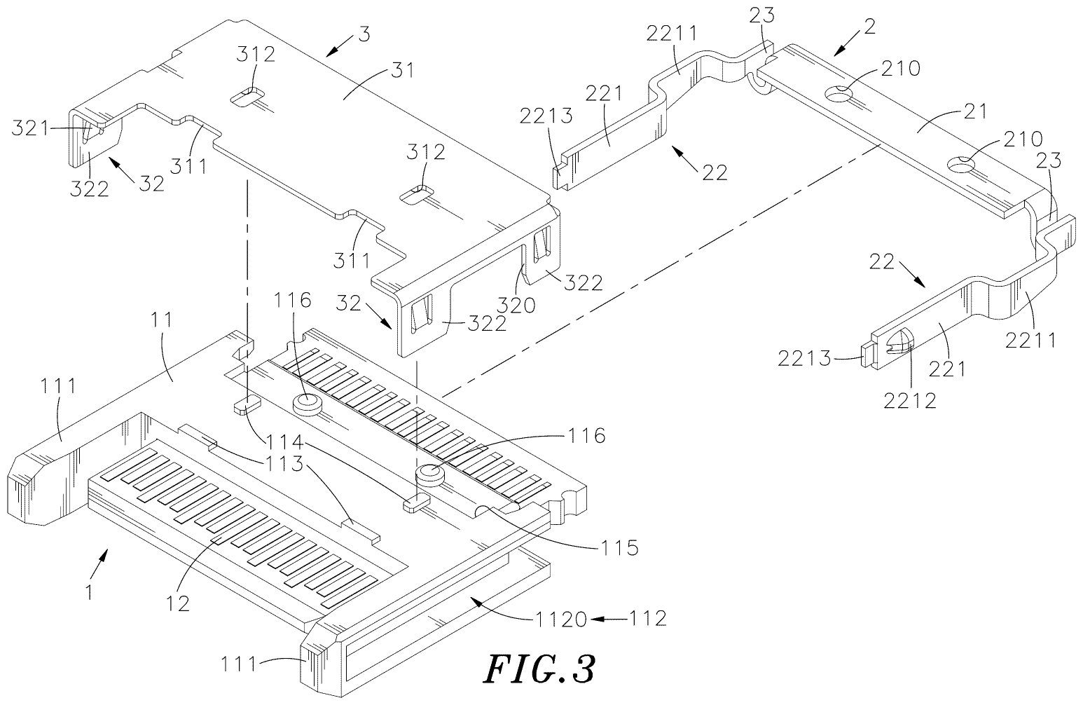

Please refer to FIGS. 1-4, which are three-dimensional appearance view of the present invention, exploded view of the plug and socket connector set of the present invention, exploded view of the plug connector of the present invention, and another perspective exploded view of the plug connector of the present invention. The plug connector buckle press release mechanism of the present invention mainly comprises a connector 1, a buckle assembly 2 and a cover shell 3, and the connection relationship between the aforementioned components is as follows:

The connector 1 comprises a base block 11, and a mating terminal set 12 mounted in the base block 11. The base block 11 comprises a docking portion 111 formed on a front side thereof, two positioning portions 112 respectively formed on two opposite lateral sides thereof, and at least one stopper 113, at least one bump 114, an accommodating groove 115 and at least one buckle block 116 provided on a top surface thereof in sequence from the docking portion 111 toward a rear side thereof. Each positioning portion 112 is provided with a limiting space 1120 and a limiting groove 1121 recessed at a front end of the positioning portion 112.

The buckle assembly 2 comprises a connecting portion 21 positioned in the accommodating groove 115 of the base block 11, at least one buckle hole 210 located on the connecting portion 21 and respectively engaged with the at least one buckle block 116, two elastic arms 22 respectively extended in the same direction on two opposite sides and respectively located in the limiting spaces 1120 of the positioning portions 112, two buffer portions 23 respectively downwardly curved from two opposite ends of the connecting portion 21 and respectively connected to respective one ends of the two elastic arms 22. Each elastic arm 22 comprises an arm body 221 extended from the respective buffer portion 23 in direction perpendicular to the connecting portion 21, a pressing portion 2211 formed of a part of the arm body 221 adjacent to the respective buffer portion 23 and exposed to the cover shell 3, a buckle portion 2212 provided on the surface of the arm body 221 near the distal end of the arm body 221 remote from the buffer portion 23, and a limiting portion 2213 protruded from the distal end of the arm body 221 and positioned in the limiting groove 1121 of the respective positioning portion 112 of the base block 11.

The cover shell 3 comprises a shell body 31, and two mounting structures 32 respectively extended downward at two opposite lateral sides of the shell body 31 and respectively assembled at the positioning portions 112 of the base block 11. The shell body 31 is provided with at least one stop groove 311 for the at least one stopper 113 of the base block 11 to be embedded to form a stop, and at least one positioning hole 312 corresponding to the at least one bump 114 for positioning. Each mounting structure 32 comprises a side panel 322 perpendicularly downwardly extended from the respective lateral side of the shell body 31, a plurality of elastic resisting pieces 321 protruding from an inner side of the side panel 322 and positioned in the limiting space 1120 of the respective positioning portion 112, and an opening 320 formed on the side panel 322 for exposing the pressing portion 2211 of the arm body 221 of the respective elastic arm 22 of the buckle assembly 2.

Furthermore, when constructing the present invention, first position the connecting portion 21 of the buckle assembly 2 in the accommodating groove 115 of the base block 11, and engage the at least one buckle hole 210 provided on the connecting portion 21 with the at least one buckle block 116 provided on the top surface of the base block 11. At the same time, the elastic arms 22 extending in the same direction on the two opposite sides of the connecting portion 21 will be positioned in the respective limiting spaces 1120 on the two opposite lateral sides of the base block 11, and the limiting portions 2213 protruding from the distal ends of the arm bodies 221 of the elastic arms 22 will be inserted into the limiting grooves 1121 of the positioning portions 112 of the base block 11 respectively to form a limit. Then position the shell body 31 of the cover shell 3 at the top surface of the base block 11 to engage the at least one stop groove 311 of the shell body 31 with the at least one stopper 113 of the base block 11 and attach the at least one positioning hole 312 of the shell body 31 onto the bump 114 of the base block 11 to form positioning. At the same time, the elastic resisting pieces 321 protruding from the respective inner sides of the mounting structures 32 on the two opposite lateral sides of the shell body 31 are buckled into the respective limiting spaces 1120 of the positioning portions 112 to form positioning, and the pressing portions 2211 provided on the arm bodies 221 of the elastic arms 22 of the buckle assembly 2 are exposed through the respective openings 320 formed on the respective side panels 322 of the two mounting structures 32. This completes the overall structure of the plug connector of the present invention.

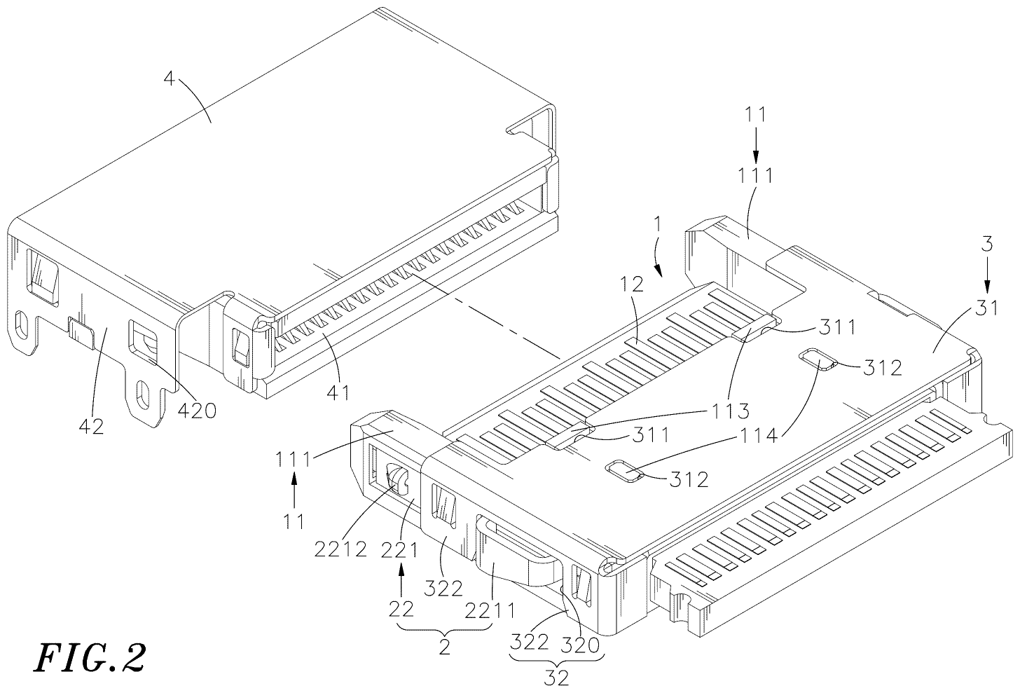

Please continue to refer to FIGS. 1 to 2, which are three-dimensional appearance views of the present invention and exploded view of the plug and socket connector set of the present invention. It can be clearly seen from the drawings that the opposing side wall panels 42 extending from two opposite lateral sides of the socket portion 41 of the socket connector 4 are provided with buckle holes 420 for the buckle portions 2212 of the arm bodies 221 on two opposite sides of the buckle assembly 2 to be buckled into position.

Please continue to refer to FIGS. 1 to 4, which are three-dimensional appearance view of the present invention, exploded view of the plug and socket connector set of the present invention, exploded view of the plug connector of the present invention, and another perspective exploded view of the plug connector of the present invention. It can be clearly seen from the drawings that when the present invention is locked, the docking portion 111 of the plug connector of the present invention is first inserted into the socket portion 41 of the socket connector 4 to form an electrical connection. At this time, the arm bodies 221 of the two elastic arms 22 are extruded by the side wall panels 42 and elastically deflect inward for a distance, and after the buckle portions 2212 of the arm bodies 221 move to the buckle holes 420, the buckle portions 2212 are elastically reset and fastened to the buckle holes 420 to form positioning.

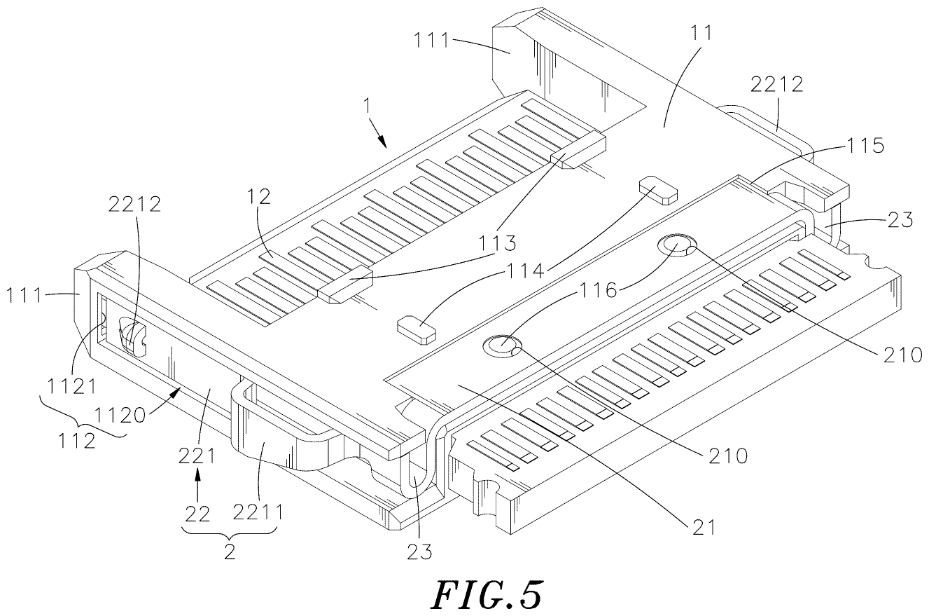

Please continue to refer to FIGS. 2 and 5, which are exploded view of the plug and socket connector set of the present invention and three-dimensional appearance view of the connector combined with the buckle assembly of the present invention. It can be clearly seen from the drawings that when unlocking, the present invention first simultaneously press the pressing portions 2211 of the elastic arms 22 of the buckle assembly 2, so that the arm bodies 221 of the two elastic arms 22 are elastically displaced inward by a distance with the pressing portions 2211 as the axis point. At this time, the buckle portions 2212 of the two arms bodies 221 will be separated from the buckle holes 420 of the socket portion 41 of the socket connector 4, so that the plug connector can easily break away from the electrical connection of the socket portion 41 of the socket connector 4, and after the plug connector is separated from the socket connector 4, the pressing of the two pressing portions 2211 is released, causing the arm bodies 221 of the two elastic arms 22 to elastically reset and shift back to their original positions.

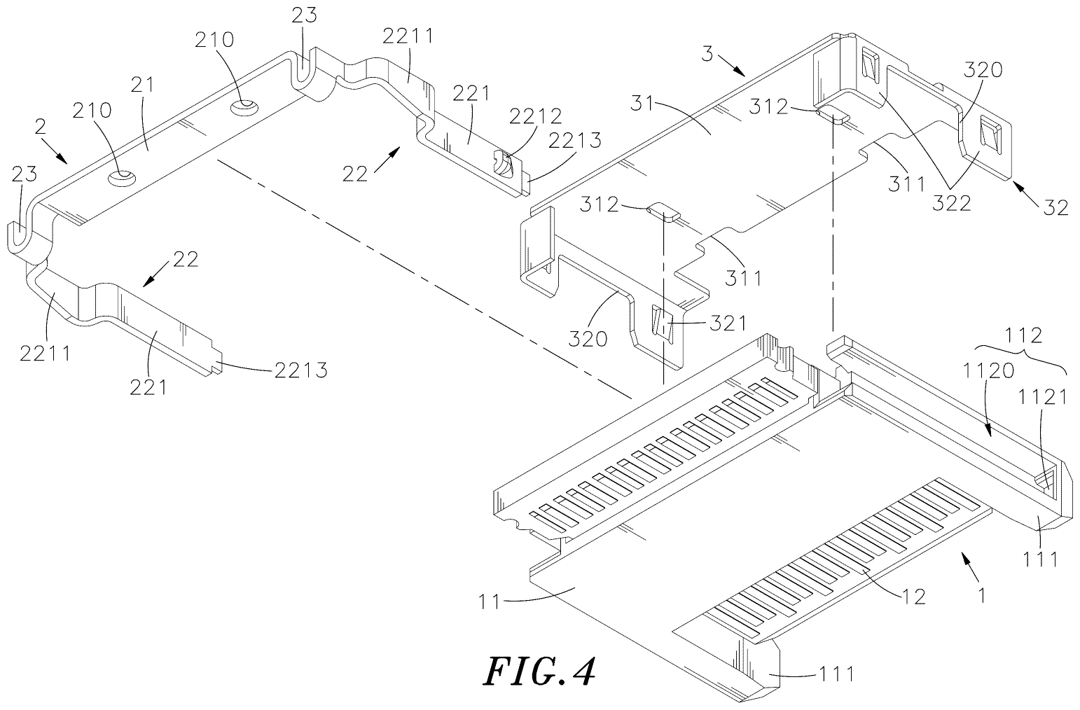

In addition, please continue to refer to FIG. 4, which is another perspective exploded view of the plug connector of the present invention. It can be clearly seen from the drawings that the limiting portions 2213 protruding from the ends of the two arm bodies 221 of the buckle assembly 2 form limits in the limiting grooves 1121 of the positioning portions 112 on both sides of the base block 11, so that the two arm bodies 221 are prohibited from deviating from the original position after elastic deflection or reset when the plug connector is locked or unlocked, so as not to affect subsequent use of the plug connector.

Furthermore, please continue to refer to FIG. 5, which is a three-dimensional appearance view of the connector combined with the buckle assembly of the present invention. It can be clearly seen from the drawing that the connecting portion 21 of the buckle assembly 2 and the two elastic arms 22 are connected with the buffer portions 23 that are turned downward to form a “U” shape, so that when the pressing portions 2211 of the two elastic arms 22 are pressed and elastically deflected, the stress can be released, thereby preventing the elastic arms 22 from breaking. In addition, the buffer portions 23 also provide space for the two elastic arms 22 to form elastic deflections. Therefore, the buffer portions 23 only need to have a shape that can release stress when elastically deflected. Such simple equal changes and modifications do not limit the scope of protection of the present invention, and are hereby stated.

In addition, the center of the docking portion 111 of the connector 1 can be the mating terminal set 12 in the form of a circuit board, so that the mating terminal set 12 can be used as an electrical connection with the socket connector 4. And the mating terminal set 12 in the docking portion 111 of the connector 1 can also be in the form of a plurality of terminals or conductive sheets designed to be used in combination with cable plugs or sockets. Such simple equal changes and modifications do not limit the scope of protection of the present invention. Such simple equal changes and modifications should still be included in the patent scope covered by the present invention.

In addition, the present invention is mainly directed to the pressing portions 2211 of the two elastic arms 22. When the pressing portions 2211 of the two elastic arms 22 are pressed, the two arm bodies 221 are elastically deflected inward by a distance with the pressing portions 2211 as the axis point. This jointly causes the buckle portions 2212 on the two arm bodies 221 to shift, so that the main feature of the present invention is to form locking or unlocking of the plug connector at the buckle holes 420 of the socket portion 41 of the socket connector 4, and the buckle portions 2212 on the two arm bodies 221 are buckled into the buckle holes 420 of the socket portion 41 of the socket connector 4 to achieve a stable docking effect.

The above description is only the preferred embodiment of the present invention, and does not limit the patent scope of the present invention. Therefore, all simple modifications and equivalent structural changes made by using the description and drawings of the present invention shall be included in the patent scope of the present invention and shall be clearly stated.

To sum up, when the plug connector buckle press release mechanism and its connector combination of the present invention are used, they can indeed achieve their effects and purposes. Therefore, the present invention is truly an invention with excellent practicality. In order to meet the application requirements for an invention patent, I filed the application in accordance with the law and hope that the review committee will approve the case as soon as possible to protect the inventor's hard work. If the review committee has any doubts, please feel free to send us a letter for instructions. The inventor will do our best to cooperate. We sincerely appreciate it.

What the invention claimed is:

1. A plug connector buckle press release mechanism, comprising a connector, a buckle assembly and a cover shell, wherein:
said connector comprises a base block externally assembled with said cover shell, and a mating terminal set mounted in said base block, said base block comprising a docking portion formed on a front side thereof and two positioning portions respectively formed on two opposite lateral sides thereof, each said positioning portion being provided with a limiting space;
said buckle assembly comprises a connecting portion positioned at a rear side of a top surface of said base block and two elastic arms respectively extended in the same direction on two opposite sides and respectively located in said limiting spaces of said positioning portions, each said elastic arm comprising an arm body extended perpendicular to said connecting portion, a pressing portion formed of a part of the respective said arm body and exposed to said cover shell and a buckle portion provided on a surface of the respective said arm body near a distal end of the respective said arm body and exposed to said cover shell.

2. The plug connector buckle press release mechanism as claimed in claim 1, wherein each said positioning portion of said base block is provided with a limiting groove recessed at a front end of said limiting space; each said elastic arm further comprises a limiting portion protruded from the distal end of each said arm body and positioned in said limiting groove of the respective said positioning portion of said base block.

3. The plug connector buckle press release mechanism as claimed in claim 1, wherein said base block further comprises at least one stopper provided on the top surface of said base block; said cover shell comprises a shell body provided with at least one stop groove for said at least one stopper of said base block to be embedded to form a stop.

4. The plug connector buckle press release mechanism as claimed in claim 1, wherein said base block further comprises at least one bump provided on the top surface of said base block; said cover shell comprises a shell body provided with at least one positioning hole for the positioning of said at least one bump of said base block.

5. The plug connector buckle press release mechanism as claimed in claim 1, wherein said base block further comprises at least one buckle block provided on the top surface of said base block; said connecting portion is provided with at least one buckle hole engaged with said at least one buckle block.

6. The plug connector buckle press release mechanism as claimed in claim 1, wherein said base block further comprises an accommodating groove recessed on the rear side of said top surface of said base block for said connecting portion of said buckle assembly to be combined.

7. The plug connector buckle press release mechanism as claimed in claim 1, wherein said buckle assembly further comprises two downwardly curved buffer portions respectively connected between two opposite ends of said connecting portion and said two elastic arms.

8. The plug connector buckle press release mechanism as claimed in claim 1, wherein said cover shell comprises a shell body and two mounting structures respectively extended downward at two opposite lateral sides of said shell body, each said mounting structure comprising a side panel perpendicularly downwardly extended from one respective lateral side of said shell body and an opening formed on said side panel for exposing said pressing portion of said arm body of one respective said elastic arm of said buckle assembly.

9. The plug connector buckle press release mechanism as claimed in claim 1, wherein said cover shell comprises a shell body and two mounting structures respectively extended downward at two opposite lateral sides of said shell body, each said mounting structure comprising a side panel perpendicularly downwardly extended from one respective lateral side of said shell body and a plurality of elastic resisting pieces protruding from an inner side of said side panel and positioned in said limiting space of the respective said positioning portion of said base block.

10. A socket connector matching up with the plug connector buckle press release mechanism as claimed in claim 1, said socket connector comprising a socket portion for said docking portion of said connector of said plug connector buckle press release mechanism to be plugged into to form an electrical connection, two opposing side wall panels extending from two opposite lateral sides of said socket portion and a buckle hole located on each said side wall panel for the respective said buckle portions of said buckle assembly to be buckled into position.
